(19) United States
(12) Patent Application Publication
(10) Pub. No.: US 2003/0213544 A1
(43) Pub. Date: Nov. 20, 2003

(54) Long-fiber foam composite, automobile door using the long-fiber foam composite, and method for manufacturing the long-fiber foam composite

(75) Inventor: Rolf Hesch, Lemgo (DE)

Correspondence Address: LERNER AND GREENBERG, P.A., POST OFFICE BOX 2480, HOLLYWOOD, FL, 33022-2480, US

(73) Assignee: MOLLER PLAST GMBH

(21) Appl. No.: 10/368,785

(22) Filed: Feb. 19, 2003

Related U.S. Application Data
(63) Continuation-in-part of application No. 09/514,269, filed on Feb. 28, 2000, now abandoned.
Application No. 09/514,269 is a continuation of application No. PCT/DE98/01777, filed on Jun. 29, 1998.

(30) Foreign Application Priority Data
Aug. 26, 1997 (DE) 197 37 014.4

(51) Int. Cl. B32B 5/18

(52) U.S. Cl. 156/79; 442/370

(57) ABSTRACT

A long fiber-foam composite material, in which the long fibers are bonded to form a loose but dimensionally stable structure with good recovery properties. The long fibers are only partially bonded by foam particles in the shape of nodal points. The unfoamed or unfoamed foam particles are inserted into the structure when the latter is being formed. The unfoamed foam particles inserted into the structure are foamed by reacting or reactivating a foaming agent previously applied to a binding agent to be foamed. The expansion can freely take place without limiting the volume so that a minimal possible thickness can be obtained by complete expansion or in a predetermined volume having a predetermined thickness, for instance, by expansion in a double wall press or a mold.

### CROSS-REFERENCE TO RELATED APPLICATION

This is a continuation-in-part of application Ser. No. 09/514,269, which is a continuation of International Application PCT/DE98/01777, filed Jun. 29, 1998, which designated the United States, now abandoned.

### BACKGROUND OF THE INVENTION

Field of the Invention

The invention concerns a long-fiber foam composite and components fabricated therefrom.

According to the state of the art, fleeces, mats, and similar padding of fibers and other longitudinally oriented structures with a high degree of thinness are bound such that they are:

mechanically fastened, e.g. through needling, quilting, felting;

welded through thermobonding if a thermoplastic material is used partly or wholly for fibers and similar; and

attached through application of adhesives by dipping, spraying, lubrication, and the like.

Foam materials and foam composite materials are known in which fibers, fleeces, fabric, and similar structures are inserted as reinforcement and in which the foam exerts a cohesive effect. This type of padding is generally referred to as a “nonwoven”.

The above products and processes possess a number of limitations, they include:

the mechanical fastening methods lead unavoidably to a thickening of the padding, which is undesirable for the majority of areas of application, especially for insulating materials;

the thermal bonding with mono-component or bi-component fibers mostly requires, depending on the area of application, a polymer fraction of between 15% and 50%. Many proven products can be fabricated in this way. But every synthesis is associated with high energy consumption and therefore with high emissions. Furthermore, chemical or synthetic fibers have high costs. Dipping and spraying is predominantly carried out with elastomers, but also with duromers and to some extent with mineral binding agents. In combination with elastomers, for example, this process allows outstanding cushioning materials to be produced. But the consumption of binding agents is high and, therefore, so is the costs and the emissions.

As a non-woven padding material for automobile seats, upholstered furniture and similar, most natural fibers have the disadvantage that they are pressed together during use, i.e. “flattened”. The lack of restoring forces of most natural fibers results in that they then remain in the flattened state.

International Patent Application No. WO 93/07318 to Nieminen et al. discloses products and processes for producing paddings, or upholsterings for clothing, furniture, and beds. The starting material used by Nieminen et al. are as follows: non-fluid and non-adhesive pieces of foam varying in size from 2 to 20 mm and short thermoplastic binder fibers having a maximum size of 40 to 50 mm. The pieces of foam and binder fibers are mixed with one another to produce “wad mats”, also called “padding mats” or “upholstery mats”. They are then thermally bonded to one another. In Nieminen et al., the pieces of foam form a matrix (i.e., the foam forms the majority of the material used) and are the actual paddings or upholsterings. The pieces of foam are bound by the binder fibers to prevent escape or expulsion from the item of clothing, the furniture upholstery, or the mattress. The pieces of foam, which are foamed in advance and are non-fluid and non-adhesive, are composed of foam wastes of all types: i.e., by-products of foam processing. However, the foams could be produced from plastics, by adding blowing agents to these and foaming them and then permitting them to cure and only then breaking up the cured foam to give pieces: e.g. by shredding, chopping, tearing, or the like. The final products are “wad mats”. Wad mats are also known as padding mats or upholstery mats in which the pieces of foam are the actual padding or upholstering material, which is prevented from escaping by binder fibers. In Nieminen et al., the linkage to the binder fibers always takes place tangentially by thermal bonding because the foam bodies are non-fluid and therefore are forced to contact the binder fibers tangentially.

U.S. Pat. No. 5,646,077 to Matsunaga et al. discloses bonding fibers via thermal bonding of the novel fiber, which in turn holds the principal fibers together in a known manner by mechanical networking/felting. The binder fiber is a polyester copolymer that includes ε-caprolactone as polyester constituent and has a melting point of not less than 100° C. Matsunaga et al. does not teach or suggest a system for producing nonwovens with zones of different density.

U.S. Pat. No. 6,159,879, which has identical inventorship as the instant application, discloses a, “Building Material Made from Bast Fibers, Shives, and a Binder.” In this patent, a foam is only used as part of a matrix; see claim 6. The foam does not appear as small foam bodies that themselves do not form a matrix.

Likewise, U.S. Pat. No. 6,207,244, which has identical inventorship as the instant application, discloses a, “Structural Element and Process for Its Production.” This patent describes fibers that are embedded in a foam matrix; see claims 1 and 7. These matrices cannot be expanded by subsequent foaming. Accordingly, they also cannot be used in moldings that utilize the pressure created by the subsequent foaming.

### SUMMARY OF THE INVENTION

It is accordingly an object of the invention to provide a long-fiber foam composite which overcomes the above-mentioned disadvantages of the prior art devices of this general type, in which long fibers are bound into a loose but dimensionally stable nonwoven with good resilience characteristics.

With the foregoing and other objects in view there is provided, in accordance with the invention, a long-fiber foam composite. The long-fiber foam composite includes small foam body particles. The small foam body particles are formed from droplets of a binding agent and a foaming agent that have been expanded by foaming. In addition, the long-fiber foam composite includes a fiber mixture of long fibers that are only partially connected to each other via the small foam body particles for forming a low density nonwoven. The small foam body particles are disposed in the low density nonwoven in an expanded form and/or a non-expanded form during a formation of the low density nonwoven. The small foam body particles that are applied in the non-expanded form (i.e. as droplets of binding agent) are expanded through a reaction with or an activation of the foaming agent of the binding agent disposed in the low density nonwoven.

In accordance with an added feature of the invention, the small foam body particles are nodally disposed in the low density nonwoven and inserted into the low density nonwoven in one of the expanded form and the non-expanded form during a formation of the low density padding. In the low density padding, foam-free zones, stretched across by the long fibers alone, are formed between the small foam body particles.

In accordance with an additional feature of the invention, the long fibers are selected from the group consisting of natural fibers, chemical fibers, synthetic fibers, and inorganic fibers. In addition, the long fibers are primary fibers, recycled fibers or mixtures of the primary fibers and the recycled fibers.

In accordance with another feature of the invention, an expansion of the small foam body particles proceeds freely without volume restriction so that it is possible to achieve a minimally possible density through complete expansion of the small foam body particles. The expansion can be carried out using a double-belt press, a mold, and a similar predetermined volume resulting in the low density nonwoven having a predetermined density.

In accordance with yet another added feature of the invention, the fiber mixture contains expanded polymer fibers that are fused together with one another at crossing points through thermobonding. In this case, the polymer fibers contain a foaming agent that is activatable through a reaction or through an input of energy during or after the formation of the low density nonwoven and that an expansion can thereby be effected.

In accordance with yet another additional feature of the invention, formed molded parts are made, using a mold, from the low density nonwoven through an input of one of energy and pressure to the mold. The formed molded parts may have zones compressed to different extents by the mold. A coating of an adhesive or a foam coating capable of adhering is applied to at least one side of the formed molded parts.

In accordance with a concomitant feature of the invention, a decorative surface coating material or a surface coating material having a technical function are glued on or foamed on the formed molded parts.

In accordance with a further object of the invention, the long fibers are natural fibers.

In accordance with a further object of the invention, the long fibers form a matrix. This contrasts the prior art where the small soft particles form a matrix.

In accordance with a further object of the invention, the small foam body particles are fluid and adhesive at room temperature initially when added to the long fibers. This allows the long fibers to be embedded in so as to cross and form nodes within the small foam particles.

In accordance with a further object of the invention, the small foam body particles have a diameter less than five millimeters (<5 mm), and preferable between one and two millimeters (1-2 mm), before being foamed. Ultimately, the small foam body particles have a diameter remaining less than 20 mm.

In accordance with a further object of the invention, the long fibers have a length from 30 mm to 150 mm, and preferably from 70 mm to 80 mm.

In accordance with a further object of the invention, an automobile door can be fashioned by including a long-fiber foam composite as described above.

In accordance with a further object of the invention, a method for manufacturing a long-fiber foam composite includes the following steps. The initial step is providing a fiber mixture of long fibers. The next step is connecting at least some of the long fibers with small foam body particles in an unexpanded state. The next step is expanding the small foam body particles with a binding agent having a foaming agent. The next step is embedding the long fibers nodally at crossing points of the long fibers during the expanding step to form a low-density nonwoven.

The term “node” (and nodally) refer to a fiber and a binding agent that surrounds the fiber. Nodes should not occur at crossing points of the fibers. If the nodes did occur at crossing points, shifting is impossible; therefore, no volume increase would occur when the binding agent is foamed.

In accordance with a further object of the invention, the method includes expanding the small foam body particles by reacting the small foam body particles with the foaming agent of the binding agent.

In accordance with a further object of the invention, the method includes expanding the small foam body particles by activating the foaming agent of the binding agent.

In accordance with a further object of the invention, the connecting step includes disposing nodally the small foam body particles in the unexpanded state on the long fibers.

In accordance with a further object of the invention, the method includes spacing the small foam body particles along the long fibers to create foam-free zones.

In accordance with a further object of the invention, the method includes free expanding the small foam body particles without volume restrictions.

In accordance with a further object of the invention, the method includes controlling a density of the low density nonwoven by controlling a volume of the low density nonwoven.

In accordance with a further object of the invention, the method includes molding the low density nonwoven to control the volume and the density.

In accordance with a further object of the invention, the method includes using a belt press to control the volume and the density.

In accordance with a further object of the invention, the method includes the steps of including polymer fibers in the fiber mixture; and thermobonding the polymer fibers at crossing points to fuse the polymer fibers.

In accordance with a further object of the invention, the method includes the step of including the foaming agent in the polymer fibers.

In accordance with a further object of the invention, the expanding step includes inputting energy to activate the foaming agent.

In accordance with a further object of the invention, the method includes enclosing the low density nonwoven in a mold; and heating the mold to activate the foaming agent.

In accordance with a further object of the invention, the method includes enclosing the low density nonwoven in a mold; and pressurizing the mold to activate the foaming agent.

In accordance with a further object of the invention, the method includes forming zones in the low density nonwoven by compressing parts of the mold to different extents.

In accordance with a further object of the invention, the method includes adding an adhesive to at least one side of the low-density nonwoven.

In accordance with a further object of the invention, the method includes attaching a decorative surface coating to the low density nonwoven with the adhesive.

In accordance with a further object of the invention, the method includes attaching a surface coating material having a technical function with the adhesive.

In accordance with a further object of the invention, the method includes the step of including a foam coating to at least one side of the low density nonwoven.

In accordance with a further object of the invention, the method includes attaching a decorative surface to the low density nonwoven with the foam coating.

In accordance with a further object of the invention, the method includes attaching a surface coating material having a technical function with the foam coating.

In accordance with a further object of the invention, the method includes selecting the long fibers from the group consisting of chemical fibers, synthetic fibers, and inorganic fibers.

In accordance with a further object of the invention, the method includes using natural fibers as the long fibers.

In accordance with a further object of the invention, the method includes selecting the long fibers from the group consisting of primary fibers, recycled fibers, and mixtures of the primary fibers and the recycled fibers.

In accordance with a further object of the invention, the method includes forming a matrix from said long fibers.

In accordance with a further object of the invention, the method includes adding the small foam body particles as a room-temperature fluid that is adhesive. Then, the long fibers are embedded within and crossed to form nodes within said small foam body particles.

Other features which are considered as characteristic for the invention are set forth in the appended claims.

Although the invention is illustrated and described herein as embodied in a long-fiber foam composite, an automobile door including the long-fiber foam composite, and a method for manufacturing the long-fiber foam composite, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic view of a foam body according to the prior art;

FIG. 2A is a diagrammatic view showing a nonwoven according to the invention with binder droplets introduced in unfoamed form between long fibers;

FIG. 2B is a diagrammatic view showing the nonwoven of FIG. 2A after foaming; and

FIG. 3 is a sectional view of an automobile door including a long-fiber foam composite according to the invention.

### DESCRIPTION OF THE PREFERRED EMBODIMENTS

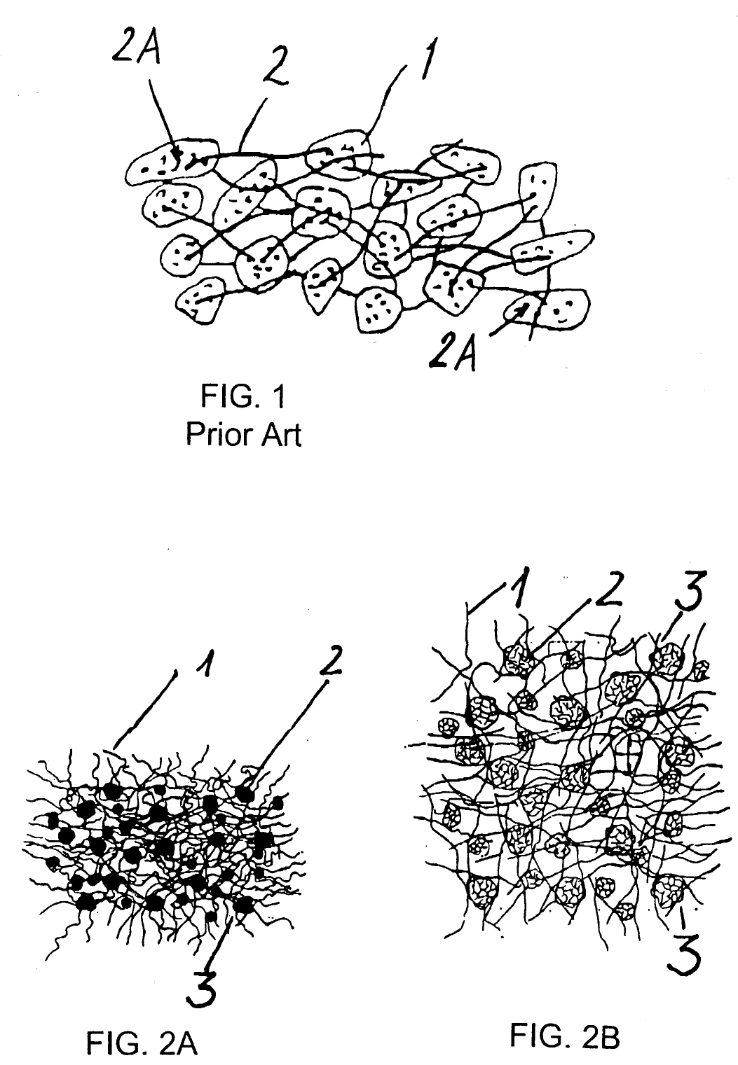

Referring now to the figures of the drawing in detail and first, particularly, to FIG. 1 thereof, there is shown a foam body according to the prior art; see especially Nieminen et al. WO 93/07318. The foam bodies 1 are cured and non-adhesive. The foam bodies are made from waste or from new foams made by shredding, breaking, and the like. The foam bodies compose the actual paddings or upholsterings. Accordingly, the foam bodies are the matrix. The binder fibers 2 are NUR polymer fibers or other fibers suitable in thermal bonding. The function of the binder fibers 2 is to bind the foam bodies together so that they do not escape, roll away, or form clumps. The foam bodies 1 and binder fibers 2 contact at fusion points 2A. Because the foam bodies 1 are non-fluid, i.e. cured, they can enclose or flow around the binder fibers. Therefore, the binder fibers 2 and foam bodies 1 only touch tangentially; i.e. they binder fibers 2 do not penetrate the foam bodies 1.

FIG. 2A shows a nonwoven according to the invention. The foamable binder droplets 2 can be in a previously foamed form when introduced between the long fibers 1 during formation of the nonwoven. This occurs when there is no desire to reduce the density below the level intrinsically brought about by the procedure for forming the nonwoven.

In contrast, if the density desired is lower than that possible via prior-art systems for forming a nonwoven, the binder droplets then have to be introduced in unfoamed form. Subsequent foaming then pushes the long fibers 1 apart. The long fibers 1 are then held internally (as opposed to tangentially) at coupling sites 3 by the droplets 2, which then cure via drying or reaction. After curing, the fibers 1 are permanently fixed and the low density is set.

The long fibers 1 preferably have a length up to one-hundred-fifty millimeters (150 mm). The binder droplets 2 preferably include blowing agent, fluid, and as shown in FIG. 2A are yet to be foamed.

FIG. 2A shows that the fluid binder 2 wets the fibers 1 partially, i.e. only at some sites. FIG. 2A further shows that there is some enclosure of the long fibers by the binder droplets. This happens because the binder droplets 2 are fluid and the adhesive forces cause them to flow around and wet the surfaces of the long fibers. This phenomena increases as the size of the droplets increases and the viscosity decreases. The result is that, at the points of contact with the adhesive droplets 2, the long fibers 1 do not remain on their surface but become integrated in them.

FIG. 2B shows the nonwoven from FIG. 2A after foaming to about twice its original height; note FIGS. 1, 2A, and 2B are roughly all drawn to scale with each other. The reference numbers are the same as in FIG. 2A: long fibers 1, binder droplets 2, and coupling site 3. The result according to the invention is a density is a density so low that it could not be achieved by the prior art.

According to the invention, the foaming may be free: i.e. without limitation of volume by a twin-belt press, mold, or the like. The result is a nonwoven with an extremely low density.

The density primarily depends on the amount of blowing agent introduced into the binder. In addition, the foaming may be limited in volume terms. For example, the volume can be limited by the production method to define densities and molding with zone-by-zone differences; e.g. for car doors.

In addition, when thermosets are used or used concomitantly, the molding produced by expansion pressure in the hot mold can be fixed directly then, in the mold.

The stresses resulting as a consequence of the foaming process do produce some degree of reorientation and stretching of the long fibers 1. As a result, the long fibers 1 may be drawn into the foam droplets 2. This can increase the strength of the bond at the coupling sites 3.

In other words, the nonwoven is a mixture of long fibers 1 that are only partially bound together through small foam bodies 2 (i.e. binder droplets) formed as nodal points to produce a nonwoven of low density. When forming the nonwoven it is possible to insert the small foam bodies 2 formed as nodal points into the nonwoven in an expanded or non-expanded state. Whereby the small foam bodies 2 inserted in the non-expanded state can be expanded through reaction or through activation of a foaming agent previously inserted in a binding agent that expands when activated. In such an embodiment of the invention, foam-free zones stretched across by the long fibers 1 alone are formed between the small foam bodies 2. As the long fibers 1, it is possible to use natural fibers 2, chemical fibers 2, synthetic fibers 2, or inorganic fibers 2, both as primary fibers and also as recycled fibers or mixtures thereof.

There are many advantages of the solution according to the invention, they include loose fiber bundles (i.e. nonwovens), especially natural fiber bundles, which according to the state of the art are of only limited suitability as upholstery because of their lack of resilience, acquire good resilience through the use of elastomers or thermo-elastic materials for the formation of the small foam bodies 2 and thus become a high-quality upholstering material. In contrast to elastomer fiber bundles according to the state of the art, in which the fibers 1 are coated as far as possible with non-expanded elastomers, the only partial use of the elastomer results in considerable economies in consumption. The foaming makes the consumption even more economical. At the same time, the foaming also leads to improved upholstery characteristics and better dimensional stability and resilience after subjection to loading. The fiber structure can also be formed more loosely, whereby savings are made in the quantity of the fibers 1 used. It can be expected that it will be possible to build up a greater market for natural fibers through the solution according to the invention.

For purposes of heat insulation, the solution according to the invention enables the main existing problem of using natural fibers to be solved. It is considered a serious deficit that insulating fleeces made from the fibers 1 of flax, hemp, sheep wool, etc. settle with time through lack of intrinsic stiffness. Over the years, this leads to loss of a considerable part of the insulating effect.

By using the small foam bodies 2 according to the invention, the natural fibers 1—and also other fibers 1—can be bound to one another in a punctiform way with a minimized outlay on the binding agent through foaming. Above all, however, the small foam bodies 2 support the fibers 1 from within and ensure that they cannot collapse together over time.

Furthermore, if the expandable materials (i.e. the small foam bodies 2) are not expanded until after insertion between the fibers 1, they drive the fibers 1 apart and effect a reduction in the density of the nonwoven, which would have been impossible to achieve without the process according to the invention. Since, as is known, the lower the density of an insulating material, the better it insulates, the process according to the invention not only provides the strived-for dimensional stability but also leads to an increase in the insulating performance beyond the natural extent.

It is known that the insulation effect derives not from the fibers 1 but from the air encapsulated in and between them. The lower the density of the fiber bundle or nonwoven, the easier it is for the air to move and thereby to reduce the insulating effect. This can be countered by protecting the insulating material from air movements from outside through lining with papers, film or other wind-proof materials, which is not shown. When forming the fleeces or other kinds of mats, such windbreaks can be attached directly to the insulating material in that the shaping process acts upon them. The bond between the fibers 1 and the windbreak can be produced, among other possibilities, through the small foam bodies 2 still being adhesive during the production process, or also through spraying on an adhesive. Windbreaks or layers intended to prevent convection within the fibers 1 can be attached on one side or both sides in the process according to the invention. Thin layers of foam or fine fleeces can also be considered as the windbreaks to be attached on one or both sides. The windbreaks can be formed as a decorative surface and/or may be formed as a surface having a technical function.

As a result of the invention, it is possible, at minimum cost, to achieve dimensional stability for light fleeces and to increase the restoring forces. The long fibers 1 glued in by a nodal configuration of the small foam bodies 2 ensure that the foam body 2 is under lateral tension and therefore that the undesirable lateral displacement and see-sawing movements typical for foam padding do not occur. The fact that only a part of the total volume is consumed by the foam 2 and the remaining part, although partially glued, is consumed by the open fibers 1 leads to especially good air permeability—a particular advantage for upholstery.

Suitable for the fabrication of the above foam composite are polymers, elastomers and also duromers in the state of the precondensate or pre-adduct. The insertion in an already expanded state should preferably be used if the intention is to form a bond to the fleece or other kind of padding without any additional reduction of the density of the padding.

The insertion of reactive expandable systems or subsequently expandable systems, e.g. through the subsequent input of energy, should preferably be used if it is intended that the expansion take place freely and it is also intended through the increase in the foam 2 to reduce the density of the fleece or other kind of nonwoven to a greater extent than this is possible through formation of the fleece itself. Alternatively, the possibility exists of carrying out the expansion process in a restricted volume, e.g. in a double-belt press or in a mold, e.g. for automobile seats. In this way, it is possible to produce specific densities that are technically necessary or desirable. The internal pressure generated by the expansion also presses the long-fiber partial foam system against inner walls of the mold and thus leads to the production of molded parts, e.g. upholstery for automobile seats. Surface layers for decorative or other purposes laid in the mold or double-belt press can thereby be expanded immediately.

An increase in the strength of the long-fiber partial foam composites can be achieved according to the invention in that the already expanded or subsequently expandable small foam bodies 2 are put as already described into a mixture of natural fibers 1 and polymer fibers 1. In addition to the nodally disposed bonding of the long fibers 1 through the partial small foam bodies 2, fusing the polymer fibers 1 at their crossing points using thermobonding can also be used to increase strength.

If it is necessary to increase the strength and simultaneously reduce the density, a requirement which is becoming increasingly important in automobile construction, it is possible to add to the mixture with the natural fibers 1, not the polymer fibers 1 according to the state of the art but, instead, such polymer fibers as were expanded (a) already during spinning, or (b) after mixing and nonwoven formation, through the input of energy which activates the foaming agent put into the melt and expands the polymer fiber 1.

Partial foam-bonded nonwovens containing mixtures of the natural fibers 1 and the polymer fibers 1, non-expanded, previously expanded or subsequently expandable, also offer the possibility that if the polymer fibers 1 or the small foam bodies 2 include heat-activatable material, bonding to metal sheets, films, fabric and similar flat materials can take place, if necessary with priming of the flat materials. In this manner, it is possible to fabricate light-weight components of high strength, e.g. automobile doors, passenger vehicle inner linings, sandwich elements of all kinds, and many other objects.

The above light-weight components can also be fabricated according to the invention as different kinds of sandwich elements if, instead of the use of the polymer fibers 1, the nonwoven is provided on one or both sides with an adhesive, or a coating of foam, which has an adhesive effect and is able to glue or thermally fuse the nonwoven with flat-shaped structures, e.g. metal sheets, decorative materials and many other objects.

Fleeces and similar objects fabricated according to the above systems can be thermoformed and subsequently compression molded if any thermoplastic components and/or duromer components they contain are not yet in a cross-linked state. At the same time, different zones of the fleeces can be compressed in the mold to different extents. In the edge zones, for example, highly compressed in order to achieve high strength and stiffness, e.g. for self-supporting parts, and only slightly compressed in the middle region in order to achieve an upholstered effect or for other reasons. According to this process, it is also possible to press ribs or embossing with selectable depth and density into the molded part for purposes of stiffening or decoration. The process is especially suitable for the fabrication of stiff, dimensionally stable and yet lightweight internal fittings for vehicles, which fittings do not splinter in the case of a crash.

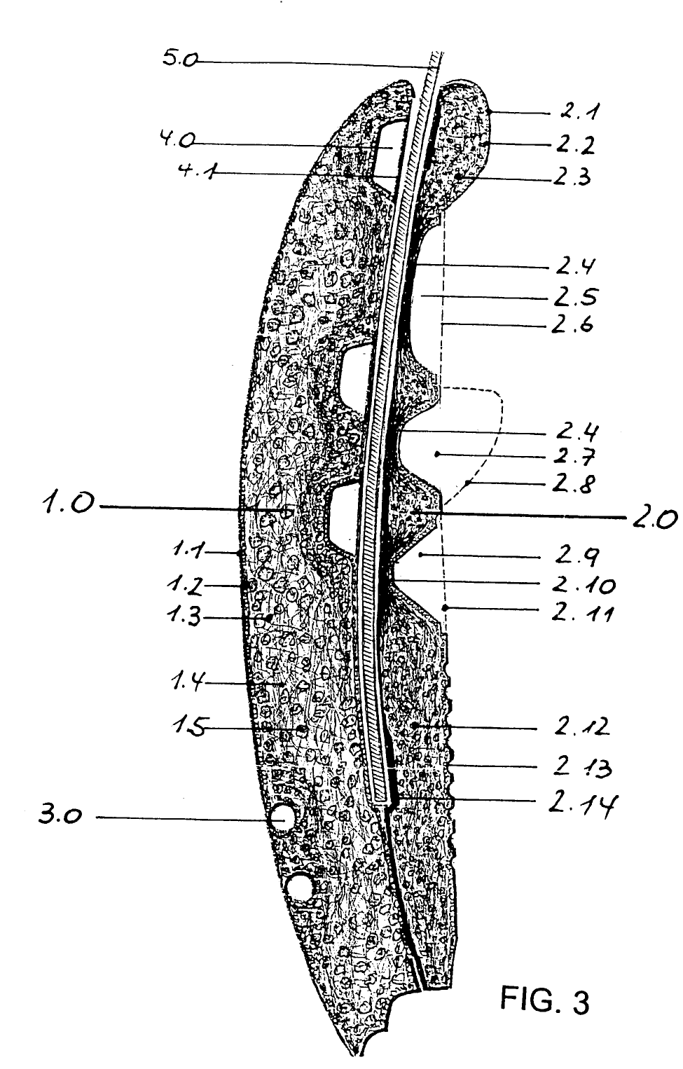

FIG. 3 shows a cross section through a car door produced using the long-fiber foam composite according to the invention. The automobile door (also referred to as a “car door”) is composed of two separately produced elements: an outer door element 1.0 and an inner door element 2.0.

Each element has different functions and correspondingly different characteristics, and therefore has to be described separately.

In addition to the known functions of the prior art, the outer door element 1.0 is also intended to increase side-impact protection, i.e. high flexural strength and high flexural impact strength, in order to supplement or replace the functioning of the safety cross-members. In addition, the outer door element 1.0 provides hip and rib protection in place of foam pads. The outer door element 1.0 provide high-performance thermal insulation, which is unavailable in the prior art.

In order to fulfill the function of side-impact protection, the long-fiber foam composite according to the invention must be built so that the elements produced therefrom have high flexural strength and flexural impact strength, and do not shatter in the event of a crash. These properties can only be generated using longfibers. It is vital that they are felted with one another (i.e. nonwoven) and also adhesive-bonded to one another, so that the high level of mechanical properties mentioned is generated. The skilled worker is aware that the tensile strength of a nonwoven increases as fiber length increases, exactly as is known to be the case for paper, strandboard, and similar materials. Both long fibers and adhesive bonding must be present together if the very high tensile strengths of the long fibers are to be transformed into equally high tensile strength and flexural strength for the elements produced therefrom. According to the invention, only “partial” adhesive bonding is intended to take place by virtue of fluid, highly adhesive binder droplets. The binder droplets can be unfoamed or previously formed. The purpose of the adhesive bonding is to prevent shifting of the individual long fibers with respect to one another in the nonwoven when subjected to force, i.e. to prevent them from being separated.

In the prior art, hip and rib protection is provided mainly by foam cushions, called pads, inserted into the hollow doors. In the event of a crash, they provide protective cushioning of the hip and rib area. At the same time, their deformation dissipates some of the energy of the impact, preventing it from acting on the body of the accident victim.

If, according to the invention, binder droplets including blowing agents are introduced between the long fibers during production of the long-fiber foam composite, and are then foamed, the result after curing of the foamed binder droplets is a very dimensionally stable, resilient long-fiber foam composite element. In such a long-fiber foam composite element, the long fibers have been laterally secured and very firmly adhesive-bonded to one another by the foam bodies. In addition, they have also been provided with support from the inside. Since the entire outer door element 1.0 is composed of this type of long-fiber foam composite, the result of the extensive lateral tensile bracing is higher compressive strength than that of small-format foam pads. The padding effect is correspondingly more effective in the inventive solution, and the protective action is correspondingly greater.

The function of the thermal insulation is likewise provided by the long fibers. However, according to the invention it is raised to a considerably higher level by the partial foam bodies. As described above, the actual thermal insulation is provided by the interstitial air between the long fibers. As the skilled worker is aware, the more interstitial air there is the better the thermal insulation. A precondition that must be imposed here is that the air cannot be moved by convection but remains still. Both preconditions are provided by the small foam bodies of the invention:

Firstly, they push the long fibers apart during the foaming process and thus permit more interstitial air to enter between the long fibers than would be possible using long fibers not supplemented by foamable binder droplets. By virtue of the foamable binder droplets, therefore, the density achieved for the nonwoven is lower than that achievable in the prior art. This raises the thermal insulation value considerably.

Secondly, the foamed binder droplets have irregularly offset positions transverse to the longitudinal axis of the respective linked long fibers and between these generate a labyrinth that increases the resistance to flow between the fibers. This makes a decisive contribution to preventing easy movement of the air by convection, and therefore to retaining the insulating action of the air.

Finally, the totality of the system of the invention provides modern automotive construction with the significant additional advantage of achieving high strength and good thermal insulation through measures that at the same time bring about a significant weight reduction of the respective components. he subsequent foaming of the binder droplets adhesive-bonded to the long fibers may be compared with the inflation of an inflatable warehouse. In its semi-inflated condition, it is unstable and oscillates to-and-fro in an uncontrolled manner. In contrast, once it has been fully inflated and its lateral traction cable has been tensioned it becomes rigid and resistant to compression and achieves a dimensional stability that can even resist storms, although the weight of the entire system is only a fraction of that of a conventional warehouse.

In FIG. 3, the reference number 1.0 generally refers to the entire outer door element. The outer skin is formed by the bodywork metal sheet 1. This sheet has been securely adhesive-bonded via a foamed layer 1.2 of a high-strength adhesive to the long-fiber foam composite 1.3 to give a sandwich element. The core of the outer door element 1.0 is composed of a mixture of long fibers 1.4. For environmental reasons these are mostly natural fibers. To increase strength inter alia by node formation using thermal bonding, and to increase thermoformability, polymer fibers with or without incorporated blowing agents have been admixed. These are partially adhesive-bonded to one another by binder droplets 1.5. After forming of the “long fiber foam composite”, which initially has the form of a mat, and coating of the outer layers with a foamable adhesive, this is cut to size or stamped, inserted into a mold with the metal door panel 1.1, and there foamed with introduction of energy. The result here is that the foaming pressure produced in the interior, depending on the mold volume present at respective locations, leads to establishment of different densities of the nonwoven produced from the long-fiber foam composite preform. The density of the nonwoven at the channels 1.6 for cables, door-lock linkages, air ducting, inter alia, and also around the safety cross-members 3.0, is higher, due to the reduced cross section, than in areas where there is no narrowing of cross section.

The density differences are illustrated by shading in FIG. 3. Light=low density; mid-gray=medium density; black=high density.

The functions of the inner door element 2.0 are different from those of the outer door element. It is intended to be part of the decorative design of the passenger compartment. The inner door element 2.0 substantially supplements the side-impact protection provided by the outerdoor element 1.0, and serves as a support for functional elements, following the trend toward the modular construction desired for the future of the automotive construction industry.

Reference number 2.1 denotes the decorative inner side of the element. During the process of compressive molding, it may be attached by adhesion to the nonwoven during the compressive molding process, using the one-shot process, or attached by foaming, or else attached subsequently by adhesion. Reference number 2.2 is the adhesive foam layer that also serves to improve feel.

Decorative materials that may be used are fabrics, films, leather, etc., covering the entire surface or in combination.

Decorative embossments 2.13 are an example of other decorative possibilities for the system.

In the region of the waistline the nonwoven 2.3 produced by foaming pressure provides a medium-density long-fiber foam composite by virtue of the mold volume available at that location. Its medium density gives it sufficient strength to provide the performance characteristics required at that location, but sufficient yielding characteristics to provide cushioning action, and therefore protection of the occupants, in the event of a crash.

Hip protection, likewise designed at medium density, is illustrated at 2.12. It is intended to replace prior-art foam-only pads for the purpose of improving hip protection. The improved protection is a result of the combination of long fibers and small adhesive-bonding foam bodies providing support from inside. The extensive lateral bracing permits dissipation and damping of the incident impact energy overrun area that is substantially greater than would be permitted by a foam pad, i.e., a trampoline effect.

A prior-art airbag 2.5 serves to protect the ribs. 2.4 is the holder to receive the airbag, produced by the process of the invention, during the compressive molding process. For this, the volume of the mold was kept so low as to produce a highly-compacted rear panel made from long fibers and from foamable binders as rear support for the airbag. At densities less than one-thousand kilograms per cubic meter (<1,000 kg/m³), the strength values come close to those of metals. Reference number 2.6 denotes a burstable membrane (bought-in component) serving as protective cover for the airbag.

The trend in the automotive construction industry is toward the modular method of construction. An example of a long-term aim is that a door is delivered fully assembled and then merely requires fitting by the car producer. The intention is that windows, window lifters, lock, lock linkages, remote-closure assembly, lifter motor, loudspeakers, etc. are to be pre-assembled within the module. All of these assemblies require supports to which they can be secured.

Since in the system of the invention the shape and strength can be adjusted via density, polymer content, thermoset content, it is possible, for example, to combine low-density cushioning subregions with highly compacted, higher-binder-content, and therefore high-strength ribs, linear reinforcement, or high-density subareas. The invention therefore permits production of a highly compacted structural system suitable for accepting the functional elements mentioned and for supporting them within the system of the module. Examples are the box 2.10 to receive a loudspeaker 2.9 with the protective covering 2.11 (third-party supply), the arm rest 2.8 (typically supplied by a third-party) with the installation space 2.7 in the compression-molded highly compacted cavity 2.4, or the airbag recess 2.5. Alongside the highly-compacted zones shown in the cross section, the invention also permits the production of vertical highly compacted support zones meeting the particular requirements of the individual case.

I claim:

1. A long-fiber foam composite, comprising:
small foam body particles including a binding agent having a foaming agent for expanding said binding agent; and
a fiber mixture of long fibers being only partially connected to each other via said small foam body particles for forming a low density nonwoven;
at least some of said small foam body particles being disposed in said low density nonwoven in a non-expanded form during a formation of said low density nonwoven;
said small foam body particles in said non-expanded form being thereby expanded through one of a reaction with and an activation of said foaming agent of said binding agent disposed in said low density nonwoven;
said small foam body particle introduced in said non-expanded form embedding said long fibers nodally at crossing points of said long fibers after having been expanded.

2. The long-fiber foam composite according to claim 1, wherein some of small foam body particles are nodally disposed in said low density nonwoven and inserted into said low density nonwoven in an expanded form during a formation of said low density nonwoven.

3. The long-fiber foam composite according to claim 1, wherein foam-free zones stretched across by said long fibers alone are formed between said small foam body particles.

4. The long-fiber foam composite according to claim 1, wherein said long fibers are selected from the group consisting of natural fibers, chemical fibers, synthetic fibers, and inorganic fibers.

5. The long-fiber foam composite according to claim 4, wherein said long fibers are selected from the group consisting of primary fibers, recycled fibers and mixtures of said primary fibers and said recycled fibers.

6. The long-fiber foam composite according to claim 1, wherein an expansion of said small foam body particles proceeds freely without volume restriction so that it is possible to achieve a minimally possible density through complete expansion of said small foam body particles.

7. The long-fiber foam composite according to claim 6, wherein the expansion can be carried out through a use of one of a double-belt press, a mold and a similar predetermined volume resulting in said low density nonwoven having a predetermined density.

8. The long-fiber foam composite according to claim 1, wherein said fiber mixture contains expanded polymer fibers that are fused together with one another at said crossing points through thermobonding.

9. The long-fiber foam composite according to claim 8, wherein said polymer fibers contain said foaming agent.

10. The long-fiber foam composite according to claim 9, wherein said foaming agent is activatable through one of a reaction and through an input of energy during or after the formation of said low density nonwoven and that an expansion can thereby be effected.

11. The long-fiber foam composite according to claim 9, wherein said polymer fibers are fused with one another at said crossing points.

12. The long-fiber foam composite according to claim 1, wherein formed molded parts are made, using a mold, from said low density nonwoven through an input of one of energy and pressure to said mold.

13. The long-fiber foam composite according to claim 12, wherein said formed molded parts have zones compressed to different extents by said mold.

14. The long-fiber foam composite according to claim 12, including a coating of an adhesive capable of adhering is applied to at least one side of said formed molded parts.

15. The long-fiber foam composite according to claim 12, including a foam coating capable of adhering is applied to at least one side of said formed molded parts.

16. The long-fiber foam composite according to claim 14, including a decorative surface coating material being one of glued on and foamed on said formed molded parts.

17. The long-fiber foam composite according to claim 14, including a surface coating material having a technical function being one of glued on and foamed on said formed molded parts.

18. The long-fiber foam composite according to claim 1, wherein said long fibers are natural fibers.

19. The long-fiber foam composite according to claim 1, wherein said long fibers form a matrix.

20. The long-fiber foam composite according to claim 1, wherein said small foam body particles are fluid at room temperature initially when added to said long fibers.

21. The long-fiber foam composite according to claim 1, wherein said small foam body particles are adhesive at room temperature initially when added to said long fibers.

22. The long-fiber composite according to claim 1, wherein said long fibers cross said small foam body particles.

23. The long-fiber composite according to claim 1, wherein said small foam body particles have a diameter less than 5 mm before being foamed.

24. The long-fiber composite according to claim 1, wherein said small foam body particles have a diameter from 1 to 2 mm before being foamed.

25. The long-fiber composite according to claim 1, wherein said small foam body particles have a diameter less than 20 mm.

26. The long-fiber composite according to claim 1, wherein said long fibers have a length from 30 mm to 150 mm.

27. The long-fiber composite according to claim 1, wherein said long fibers have a length from 70 mm to 80 mm.

28. An automobile door, comprising:
a long-fiber foam composite including small foam body particles having a binding agent with a foaming agent for expanding said binding agent, and a fiber mixture of long fibers being only partially connected to each other via said small foam body particles for forming a low density nonwoven, at least some of said small foam body particles being disposed in said low density nonwoven in a non-expanded form during a formation of said low density nonwoven, said small foam body particles in said non-expanded form being thereby expanded through one of a reaction with and an activation of said foaming agent of said binding agent disposed in said low density nonwoven, said small foam body particle introduced in said non-expanded form embedding said long fibers nodally at crossing points of said long fibers after having been expanded.

29. A method for manufacturing a long-fiber foam composite, which comprises:
providing a fiber mixture of long fibers;
connecting at least some of the long fibers with small foam body particles in an unexpanded state;
expanding the small foam body particles with a binding agent having a foaming agent; and
embedding the long fibers nodally at crossing points of the long fibers during the expanding step to form a low density nonwoven.

30. The method according to claim 29, which further comprises expanding the small foam body particles by reacting the small foam body particles with the foaming agent of the binding agent.

31. The method according to claim 29, which further comprises expanding the small foam body particles by activating the foaming agent of the binding agent.

32. The method according to claim 29, which further comprises, in the connecting step, disposing nodally the small foam body particles in the unexpanded state on the long fibers.

33. The method according to claim 29, which further comprises spacing the small foam body particles along the long fibers to create foam-free zones.

34. The method according to claim 29, which further comprises free expanding the small foam body particles without volume restrictions.

35. The method according to claim 29, which further comprises controlling a density of the low density nonwoven by controlling a volume of the low density nonwoven.

36. The method according to claim 35, which further comprises molding the low density nonwoven to control the volume and the density.

37. The method according to claim 35, which further comprises using a belt press to control the volume and the density.

38. The method according to claim 29, which further comprises:
including polymer fibers in the fiber mixture; and
thermobonding the polymer fibers at crossing points to fuse the polymer fibers.

39. The method according to claim 38, which further comprises including the foaming agent in the polymer fibers.

40. The method according to claim 39, which further comprises, in the expanding step, inputting energy to activate the foaming agent.

41. The method according to claim 29, which further comprises:
enclosing the low density nonwoven in a mold; and
heating the mold to activate the foaming agent.

42. The method according to clam 29, which further comprises:
enclosing the low density nonwoven in a mold; and
pressurizing the mold to activate the foaming agent.

43. The method according to claim 42, which further comprises forming zones in the low density nonwoven by compressing parts of the mold to different extents.

44. The method according to claim 29, which further comprises adding an adhesive to at least one side of the low density nonwoven.

45. The method according to claim 44, which further comprises attaching a decorative surface coating to the low density nonwoven with the adhesive.

46. The method according to claim 44, which further comprises attaching a surface coating material having a technical function with the adhesive.

47. The method according to claim 29, which further comprises including a foam coating to at least one side of the low density nonwoven.

48. The method according to claim 47, which further comprises attaching a decorative surface to the low density nonwoven with the foam coating.

49. The method according to claim 47, which further comprises attaching a surface coating material having a technical function with the foam coating.

50. The method according to claim 29, which further comprises selecting the long fibers from the group consisting of chemical fibers, synthetic fibers, and inorganic fibers.

51. The method according to claim 29, which further comprises using natural fibers as the long fibers.

52. The method according to claim 29, which further comprises selecting the long fibers from the group consisting of primary fibers, recycled fibers, and mixtures of the primary fibers and the recycled fibers.

53. The method according to claim 29, wherein the long fibers are natural fibers.

54. The method according to claim 29, which further comprises forming a matrix from the long fibers.

55. The method according to claim 29, wherein the small foam body particles are fluid at room temperature initially when added to the long fibers.

56. The method according to claim 55, which further comprises embedding the long fibers cross within the small foam body particles.

57. The method according to claim 29, wherein the small foam body particles are adhesive at room temperature initially when added to the long fibers.

58. The method according to claim 29, wherein the small foam body particles have a diameter less than 5 mm before being foamed.

59. The method according to claim 29, wherein the small foam body particles have a diameter from 1 to 2 mm before being foamed.

60. The method according to claim 29, wherein the small foam body particles have a diameter less than 20 mm.

61. The method according to claim 29, wherein the long fibers have a length from 30 mm to 150 mm.

62. The method according to claim 29, wherein the long fibers have a length from 70 mm to 80 mm.
